(19) United States
(12) Patent Application Publication
(10) Pub. No.: US 2003/0054944 A1
(43) Pub. Date: Mar. 20, 2003

(54) Catalyst for polyethylene giving an improved short chain branching distribution

(76) Inventors: Christine Chabrand, Carry le Rouet (FR); Muriel Esteban, Lavera (FR); Charles Jenny, Martigues (FR); Eric Osmont, Martigues (FR)

Correspondence Address: Finnegan, Henderson, Farabow,, Garrett & Dunner, L.L.P., 1300 I Street N.W., Washington, DC, 20005-3315, US

(21) Appl. No.: 10/098,196

(22) Filed: Mar. 15, 2002

Related U.S. Application Data
(63) Continuation of application No. PCT/GB00/03536, filed on Sep. 14, 2000.

(30) Foreign Application Priority Data
Sep. 17, 1999 (EP) 99430020.0

(51) Int. Cl. B01J 31/00

(52) U.S. Cl. 502/118; 502/102; 502/103

(57) ABSTRACT

A catalyst composition for polymerising ethylene with a superior activity, productivity, and giving, in particular, copolymers with an improved narrower short chain branching distribution, and especially an improved cling development in PIB formulated films. The catalyst composition for the (co-)polymerisation of ethylene, optionally with an alpha olefin of 3 to 10 carbon atoms, has a catalyst precursor and an organoaluminium cocatalyst, wherein the catalyst precursor has i) a catalyst carrier material, having from 0.3 to 1.2 mmoles of OH groups per gram of catalyst carrier; ii) a dialkylmagnesium compound of the formula RMgR¹, where R and R¹ are the same or different C2-C12 alkyl groups, in an amount between 1.1 and 2.4 mmoles of diakylmagnesium per gram of catalyst carrier; iii) a tetraalkyl orthosilicate, in which the alkyl group contains from 2 to 6 carbon atoms, in an amount between 0.4 and 1.6 mmoles of tetraalkyl orthosilicate per gram of catalyst carrier; and iv) a titanium compound in an amount between 1.3 to 2.4 mmoles per gram of catalysts carrier.

The present invention relates to a method for the (co-)polymerisation of ethylene, to a catalyst composition for such a (co-)polymerisation and to a method for the preparation of such a catalyst composition.

It is an object of the present invention to provide a catalyst composition for polymerising ethylene with a superior activity, productivity, and giving, in particular, copolymers with an improved narrower short chain branching distribution, and especially an improved cling development in PIB formulated films.

International patent application WO95/13873 discloses a method for producing linear low density copolymers of ethylene ( “LLDPE”) in the presence of a high activity polyethylene catalyst. Said patent application claims a catalyst composition for copolymerising ethylene and an alpha olefin of 3 to 10 carbon atoms, comprising a catalyst precursor and a trialkylaluminium cocatalyst to activate said catalyst precursor, wherein the precursor comprises

(i) silica,

(ii) dibutylmagnesium,

(iii) tetraethyl orthosilicate,

(iv) and TiCl₄,

each of the catalyst precursor components being used in specified ratios.

A catalyst composition has now unexpectedly been found which exhibits an improved activity, and which allows to produce in particular copolymers with an improved short chain branching distribution, keeping also a good average particle size distribution. The polyethylene polymers produced with the catalyst compositions according to the present invention can be linear low density polyethylene (LLDPE) as well as high density polyethylene (HDPE).

According to the present invention, the catalyst composition for the (co-)polymerisation of ethylene, optionally with an alpha olefin of 3 to 10 carbon atoms, comprises a catalyst precursor and an organoaluminium cocatalyst, wherein the catalyst precursor comprises

i) a catalyst carrier material, having from 0.3 to 1.2 mmoles of OH groups per gram of catalyst carrier, more preferably from 0.3 to 0.8,

ii) a dialkylmagnesium compound of the formula RMgR¹, where R and R¹ are the same or different C2-C12 alkyl groups, in an amount comprised between 1.1 and 2.4 mmoles of dialkylmagnesium per gram of catalyst carrier, preferably between 1.3 and 2.4, more preferably between 1.3 and 1.8,

iii) a tetraalkyl orthosilicate, in which the alkyl group contains from 2 to 6 carbon atoms, in an amount comprised between 0.4 and 1.6 mmoles of tetraalkyl orthosilicate per gram of catalyst carrier, more preferably between 0.6 and 1.3 , and

iv) a titanium compound in an amount comprised between 1.3 to 2.4 mmoles per gram of catalyst carrier, more preferably between 1.3 and 1.8.

The catalyst carrier materials which can be used in the present invention are solid, porous carrier materials such as e.g. silica, alumina and combinations thereof. They are preferably amorphous in form. These carriers may be in the form of particles having a particle size of from about 0.1 micron to about 250 microns, preferably from 10 to about 200 microns, and most preferably from about 10 to about 80 microns. The preferred carrier is silica, preferably silica in the form of spherical particles e.g. spray dried silica.

The internal porosity of these carriers may be larger than 0.2 cm³/g, e.g. larger than about 0.6 cm³/g. The specific surface area of these carriers is preferably at least 3 m²/g, preferably at least about 50 m²/g, and more preferably from, e.g. about 150 to about 1500 m²/g. It is desirable to remove physically bound water from the carrier material prior to contacting this material with water-reactive magnesium compounds. This water removal may be accomplished by heating the carrier material to a temperature from about 100° C. to an upper limit of temperature represented by the temperature at which change of state or sintering occurs. A suitable range of temperatures may, thus, be from about 100° C. to about 850° C. Preferably, said temperature is comprised between 500° C. and 800° C.

Silanol groups represented by a presence of Si—OH groups in the carrier are present when the carrier is contacted with water-reactive magnesium compounds in accordance with the present invention. These Si—OH groups are present at about 0.3 to about 1.2 mmoles of OH groups per gram of carrier, preferably at about 0.3 to about 0.7 mmoles of OH groups per gram of carrier. Excess OH groups present in the carrier may be removed by heating the carrier for a sufficient time at a sufficient temperature to accomplish the desired removal. For example, the silica carrier, prior to the use thereof in the first catalyst synthesis step has been dehydrated by fluidising it with nitrogen or air and heating at least at about 600° C. for at least about 5 hours to achieve a surface hydroxyl group concentration of less than about 0.7 mmoles per gram (mmoles/g).

The surface hydroxyl concentration (OH) of silica may be determined according to J. B. Peri and A. L. Hensley, Jr., J. Phys. Chem., 72(8), 2926 (1968).

The silica of the most preferred embodiment is a material marketed under the tradename of ES70 by Crosfield and having a surface area of 280 m²/g and a pore volume of 1.6 ml/g. Another preferred silica is a high surface area, amorphous silica (surface area=300 m²/g; pore volume of 1.65 cm³/g), and it is a material marketed under the tradename of Davison 952 by the Davison Chemical Division of W. R. Grace and Company.

The dialkylmagnesium composition according to the present invention has the empirical formula RMgR¹ where R and R¹ are the same or different C₂-C₁₂ alkyl groups, preferably C₂-C₈ alkyl groups, more preferably C₄-C₈ alkyl groups, and most preferably both R and R¹ are butyl groups. Butylethylmagnesium, butyloctylmagnesium and dibutylmagnesium are preferably used according to the present invention, dibutylmagnesium being the most preferred.

The tetraalkyl orthosilicate according to the present invention has the formula Si(OR)₄ wherein R is C₂-C₆ alkyl compound. Typical examples of tetraalkyl orthosilicate which can be used in accordance with the invention include tetramethoxysilane, tetraethoxysilane, tetraisopropoxysilane, tetrapropoxysilane, tetrabutoxysilane.

Tetrabutoxysilane is preferably used according to the present invention.

The transition metal compounds are titanium compounds, preferably tetravalent titanium compounds. The most preferred titanium compound is titanium tetrachloride.

Mixtures of such titanium metal compounds may also be used.

Examples of organoaluminium cocatalysts which can be used according to the present invention are dimethylaluminiumchloride, trimethylaluminium, triisobutylaluminium or triethylaluminium. Preferably, triethylaluminium is used.

Catalysts produced according to aspects of the present invention may be described in terms of the manner in which they can be made. More particularly, these catalysts can be described in terms of the manner in which a suitable carrier may be treated in order to form such catalysts.

The catalyst precursor according to the present invention is preferably prepared via a multi-step process which comprises the steps of:

(1) reacting in a solvent a catalyst carrier material, having from 0.3 to 1.2 mmoles of OH groups per gram of catalyst carrier, with a dialkylmagnesium compound of the formula RMgR¹, where R and R¹ are the same or different C₂-C₁₂ alkyl groups, in an amount comprised between 1.3 to 3 mmoles of dialkylmagnesium per gram of catalyst carrier, more preferably between 1.5 to 2 6 mmoles of dialkylmagnesium per gram of catalyst carrier,

(2) extracting the supernatent solution and washing the product from step (1) up to obtain less than 1% of magnesium compound in the last extraction in comparison with the amount of Mg initially added during the reaction, and from 1.3 to 2.4 mmoles of dialkylmagnesium per gram of catalyst carrier, more preferably from 1.3 to 1.8 mmoles of dialkylmagnesium per gram of catalyst carrier,

(3) reacting said carrier supported organomagnesium composition with a tetraalkyl orthosilicate, in which the alkyl group contains from 2 to 6 carbon atoms, in an amount comprised between 0.4 to 1.6 mmoles per gram of catalyst carrier, more preferably between 0.6 to 1.3 mmoles per gram of catalyst carrier, and

(4) contacting the product from step (3) with a titanium compound in an amount comprised between 1.3 to 2.4 mmoles per gram of catalyst carrier, more preferably between 1.3 to 1.8 mmoles per gram of catalyst carrier.

The prepared catalyst precursor is subsequently contacted with an organoaluminium cocatalyst to activate the catalyst.

The preparation of the catalyst precursor is done for example according to the following preparation procedure:

The carrier material, e.g. preferably silica, is slurried in a non-polar solvent and the resulting slurry is contacted with at least one organomagnesium composition. The slurry of the silica carrier material in the solvent is prepared by introducing the carrier into the solvent, preferably while stirring, and heating the mixture to about 25° to about 100° C., preferably to about 40° to about 60° C. The slurry is then contacted with the aforementioned organomagnesium composition while the heating is continued at the aforementioned temperature.

Suitable non-polar solvents are materials in which all of the reactants used herein, e.g. the organomagnesium composition (dialkylmagnesium), the tetraalkyl orthosilicate and the transition metal (Ti) compound, are at least partially soluble and which are liquid at reaction temperatures. Preferred non-polar solvents are alkanes, such as isopentane, hexane, n-heptane, octane, nonane, and decane, although a variety of other materials including cycloalkanes, such as cyclohexane, aromatics, such as benzene and ethylbenzene, may also be employed. The most preferred non-polar solvent is hexane. Prior to use, the non-polar solvent should be purified, such as by percolation through silica gel and/or molecular sieves, to remove traces of water, oxygen, CO₂, polar compounds, and other materials capable of adversely affecting catalyst activity

It is important to saturate the silica carrier with the dialkylmagnesium compound in order to avoid direct reactions between the silica carrier and the other chemical reagents. This is shown by measuring the OH content after the addition of the dialkylmagnesium. It is also important to extract all the magnesium species which have not reacted with the silica support in order to avoid any secondary reactions between the excess of magnesium species and the other chemical reagents. The extraction of the supernatent solution is done after stopping stirring, leaving the silica settled, at a temperature of about 25° to about 100° C., preferably 40° to about 60° C. This is followed by the (repeated) addition of a sufficient amount of the same solvent used to slurry the silica carrier, stirring from 5 min to 30 min, leaving the silica settled after having stopped the stirring, extracting the supernatent solution. These operations are carried out up to obtain less than 1% of magnesium in the last extraction (in comparison with the amount of Mg initially added during the reaction).

The slurry of the silica carrier material and of organomagnesium composition in the solvent is preferably maintained at a temperature comprised between 25° C. and 100° C., preferably between 40° C. and 60° C., for introduction of the tetraalkyl orthosilicate compound. The tetraalkyl orthosilicate compound is introduced after organomagnesium incorporation.

The contact of the transition metal compound with the liquid medium conveniently takes place by slurrying the solid carrier containing the reactive magnesium composition with the neat transition metal compound and maintaining the resulting liquid medium at a temperature comprised between 25° C. and 100° C., preferably between 40° C. and 60° C.

Once all of the catalyst components have been brought into contact according to the present invention, the resulting slurry is then preferably heated and maintained at a temperature between about 25° C. and 65° C. in order to proceed with the synthesis step. Preferably, this synthesis step is conducted at a temperature between 30° C. and 60° C., more preferably between 45° C. and 55° C. Preferably the catalyst is then subjected to a conventional drying step.

The final catalyst precursor thus obtained is then activated with suitable activators. Suitable activators include the organoaluminium cocatalysts already disclosed hereabove.

The catalyst may be activated in situ by adding the activator and catalyst separately to the polymerisation medium. It is also possible to combine the catalyst and activator before introduction into the polymerisation medium, e.g. for up to about 2 hours at a temperature from −10° to about 80° C.

A suitable activating amount of the activator may be used. The number of moles of activator per gram atom of titanium in the catalyst may be, e.g. from about 1 to about 100 and is preferably greater than about 3.

Alpha-olefins, preferably ethylene may be polymerised with the catalysts prepared according to aspects of the present invention by any suitable process. Such processes include polymerisations carried out in suspension, in solution or in the gas phase. Gas phase polymerisations are preferred such as those taking place in stirred bed reactors and, especially, in fluidised bed reactors.

The molecular weight of the polymer may be controlled in a known manner, preferably by using hydrogen. With the catalysts produced according to aspects of the present invention, molecular weight may be suitably controlled with hydrogen when the polymerisation is carried out at relatively low temperatures, e.g. from about 30° to about 115° C. This control of molecular weight may be evidenced by a the measurement of the melt index (MI_{2.16}) for the polymer produced.

In order to achieve the desired density ranges for the copolymers it is necessary to copolymerise enough of the alpha-olefin comonomers with ethylene. The amount of the comonomer needed to achieve this result will depend on the particular comonomer(s) employed.

It is essential to operate the fluid bed reactor at a temperature below the sintering temperature of the polymer particles. For the production of ethylene copolymers in the process of the present invention an operating temperature of about 30° C. to 115° C. is preferred, and a temperature of about 85° C. to 115° C. is most preferred.

The fluid bed reactor is operated at pressures of up to about 1000 psi, and is preferably operated at a pressure of from about 150 to 350 psi.

According to a preferred embodiment, the process of the present invention preferably applies to the manufacture of polyolefins in the gas phase by the copolymerisation of ethylene with but-1-ene and/or hex-1-ene and/or 4-methylpent-1-ene. The process according to the present invention may be used to prepare a wide variety of polymer products for example linear low density polyethylene (LLDPE) based on copolymers of ethylene with but-1-ene, 4-methylpent-1-ene or hex-1-ene and high density polyethylene (HDPE) which can be for example copolymers of ethylene with a small portion of higher alpha olefin, for example, but-1-ene, pent-1-ene, hex-1-ene or 4-methylpent-1-ene.

When using the catalyst according to the present invention it is possible to produce polymers showing a broad range of molecular weight distribution, i.e. from narrow to broad.

The molecular weight distribution of a polymer is usually indicated by the melt flow ratio value. Said melt flow ratio (MFR) is the ratio of the high load melt index (HLMI_{21.6}) to the melt index (MI_{2.16}) of the polymer, which are measured according to ASTM-D-1238.

When comparing the catalysts of the present invention with those prepared on the basis of the aforementioned International patent application WO95/13873 surprising advantage of the present invention was found, on top of the already identified benefits of the invention: indeed the new range of reagent amounts which are used in the present invention allows to obtain in the case of a comonomer addition, an improved short chain branching distribution (SCBD).

Improvement of short chain branching distribution may be evaluated by measuring:

(1) the percent of comonomer incorporated in the polyethylene chain by Fourier Transform Infrared spectrometry (FTIR). For example, if hexene is used as comonomer, the measurement is based on optical density ratio of the methyl band absorption at 1378 cm−1 over methylene band at 1365 cm−1 , and

(2) the fraction of low branched molecules determined by the melting enthalpy above 125° C. (%>125° C.), measured by Differential Scanning Calorimetry This method is based on polymer fractionation according to short chain branching content through stepwise isothermal crystallisations. Then, the melting endotherm is recorded. Several peaks are obtained corresponding to each crystallisation step. Lower is the melting Temperature, higher is the short chain branching frequency. The higher temperature peak correspond the lowest branched fraction of the polymer. This fraction is quantified by the partial area of the peak over the total melting endotherm identified by %>125° C.

As a matter of fact, the %>125° C. is affected by two factors:

a—the overall comonomer content incorporated in the main chains measured by FTIR.

b—The comonomer distribution accross the whole polymer.

While not wishing to be bound to a theory, the Applicants believe that for a given catalyst system, this can be expressed in the range of the current comonomer content by the following equation:

%>125° C.=B−A*(% comonomer) A, B>0

When comparing different catalyst system to a reference, the one giving the polymer with the most homogeneous SCBD will be the one giving the lowest %>125° C. values having the lowest B constant.

The SCBD strongly influences the blown film crystallinity used for packaging application. For instance, PIB formulated blownstrech films develop fast cling properties when less thick lamellea, corresponding to %>125° C. values, are present in the film. Others film properties such as hexane extractables, film blocking, opticals and some mechanical properties are also affected by the SCBD.

The catalysts prepared according to aspects of the present invention have an improved productivity. Moreover, the copolymer exhibits an unexpected better short chain branching distribution, as this is demonstrated by the following examples.

### EXAMPLES

A. Catalyst preparation

Comparative Example 1

12 Kg of Crosfield ES70 silica, which had been heated to 700° C. for about 5 hours under a dry nitrogen purge, was slurried in hexane contained in a 140 l pilot plant reactor kept under a continuous nitrogen purge and equipped with a stirrer.

The slurry was stirred at 166 rpm and heated to 50° C., then 14.81 of dibutyl magnesium (DBM, 0.812 M) were added dropwise to the slurry, and the mixture stirred for 1 hour.

Then dehydrated tetrabutoxy silane (TBOS) solution (2.83 l, 2.8 M) was introduced and the mixture stirred for 2 h. Finally, 1.32 l of pure TiCl4 were added dropwise, and the stirring was continued for an additional hour at 50° C.

The solvent was removed under vacuum at 40° C.

The catalyst analysis is reported in Table 1.

Comparative example 2

The catalyst is a silica supported catalyst which is the same as the one disclosed in the comparative example 1 of WO 99/05187 (1 mmol DBM/g silica, 0.44 mmol TEOS/g silica, 1 mmol TiCI4/g silica).

The catalyst analysis is reported in Table 1.

### Example 1

12 Kg of Crosfield ES70 silica, which had been heated to 700° C. for about 5 hours under a dry nitrogen purge, was slurried in hexane contained in a 140 l pilot plant reactor kept under a continuous nitrogen purge and equipped with a stirrer.

The slurry was stirred at 166 rpm and heated to 50° C., then 29.61 of dibutyl magnesium (DBM, 0.812 M) were added dropwise to the slurry, and the mixture stirred for 1 hour.

Next, 100 l of hexane were added at the same temperature and the mixture stirred again during ¼ h and settled (½ h) before removing 122 l of the supernatent solution.

Three washings each with 130 l of fresh solvent were performed in the same conditions.

Then 20 l of hexane were introduced with dehydrated TBOS solution (4.3 l, 2.8 M), and the mixture stirred for 2 h.

Finally, 2.1 l of pure TiCL4 were added dropwise, and the stirring was continued for an additional hour at 50° C.

The solvent was removed under vacuum at 40° C.

The catalyst analysis are reported in table 1.

Moreover.

the Malvern analysis of this catalyst was comparable to the comparative example analysis, showing that no morphology degradation occurred by increasing the reagent amounts:

ex: 1 aps=43.1 μm, %of<15 μm=7.9%

compa.ex 1 aps=43.1 μm, %of<15 μm7.5%

no OH groups bounded onto the silica was found after the DBM addition, when half of the OH present after silica calcination was still measured in the case of comparative example 1. This shows that the silica of example 1 was saturated in magnesium

### Examples 2to 4

Catalysts were prepared in the laboratory at ca.20 g scale. The silica used was ES70 manufactured by Crosfield, calcined at 700° C., 5 hours under nitrogen. The solvent used was hexane. 20 g of the silica was added to a glass reactor containing about 200 ml solvent and equipped with a stirrer. The slurry was stirred at 250 rpm and heated to 50° C.

Dibutyl magnesium (DBM) was then added at an amount of 2 mmol per g of silica and the mixture stirred for 1 hour. For some catalysts, the stirring was stopped, the supernatant solution extracted after the silica was settled, and 200 ml fresh solvent was introduced into the reactor. The slurry was stirred again during 15 min, and the previous extraction operation was repeated. 2 washings were carried out on the same manner.

According to the catalyst, different amounts of Tetrabutoxysilane (TBOS) were then added and the mixture stirred for 2 hours.

Then the temperature was decreased down to 45° C., and different amounts of Titanium tetrachloride (TiCl4) according to the catalyst were introduced. The slurry was stirred at 50° C. an additional hour, then it was transferred by cannular to a schlenk tube and dried under a flow of nitrogen at 50° C.

The final drying step was performed under vacuum at ambient temperature, then the catalyst was stored in a glovebox.

The washing conditions and the different used amounts of TBOS (TEOS*) and TiCl4 are reported in Table 1, as well as the catalyst analysis.

TABLE 1
catalyst analysis for the different amounts of TBOS (TEOS*) and TiCl4 introduced

| | | | Mg | OH | Mg/OH | TBOS | TiCl4 | |
|---|---|---|---|---|---|---|---|---|
| | % w Ti/ | % w Mg/ | mM/ | mM/ | molar | TEOS* | mM/ | washing |
| | w.cata | w. cata | g silica | g silica | ratio | mM/g silica | g silica | conditions |
| C. ex 1 | 3.1 | 1.45 | 1 | 0.52 | 1.9 | 0.66 | 1 | no |
| C. ex 2 | 3.27 | 1.83 | 1 | 0.4 | 2.5 | 0.44* | 1 | no |
| ex. 1 | 3.9 | 2 | 2 | 0.52 | 3.8 | 1 | 1.6 | extrac + 3 w. |
| ex. 2 | 4.8 | 2.3 | 2 | 0.52 | 3.8 | 0.66 | 1.5 | extrac + 1 w. |
| ex. 3 | 3.6 | 1.44 | 2 | 0.52 | 3.8 | 0.86 | 1.3 | extrac + 1 w. |
| ex. 4 | 4.26 | 2.03 | 2 | 0.52 | 3.8 | 0.52 | 1.3 | extrac + 1 w. |

B. Slurry Phase Testing (SPT)

In a 5 liter stainless steel reactor containing hexane, hexene-1 and triethylaluminium (TEA) are introduced, then hydrogen and ethylene. The catalyst is then injected into the reactor. A constant pressure is kept in the reactor by ethylene feed. After 1 h of polymerisation, the ethylene feed is stopped, the reactor degassed and cooled. The slurry of copolymer is recovered and the powder is separated from the solvent, then pelletized. The polymerisation conditions and results are summarised in the following table.

| | C. ex 1 | C. ex 1 | C. ex 1 | Ex. 1 | Ex. 2 | Ex. 3 | Ex. 4 |
|---|---|---|---|---|---|---|---|
| Temperature (° C.) | 85 | 85 | 85 | 85 | 85 | 85 | 85 |
| pC2 (barg) | 4 | 4 | 4 | 4 | 4 | 4 | 4 |
| pH2 (barg) | 0.7 | 1.2 | 0.91 | 0.7 | 0.6 | 0.5 | 0.6 |
| C6 (ml) | 300 | 400 | 425 | 400 | 425 | 400 | 450 |
| mMTi | 0.1 | 0.06 | 0.03 | 0.03 | 0.03 | 0.05 | 0.04 |
| TEA (mmol) | 3 | 3 | 3 | 3 | 3 | 3 | 3 |
| activity (g/mmolTi/b/h) | 426 | 659 | 498 | 760 | 567 | 352 | 389 |
| productivity (g/g/h/b) | 276 | 427 | 322 | 691 | 658 | 263 | 397 |
| pellets MI | 0.94 | 1.2p | 0.81 | 1.7 | 0.6 | 0.7 | 0.8 |
| pellets MFR | 25.9 | 28.6p | 27.51 | 30.7 | 29.5 | 35.8 | 34 |
| pellets density g/cm3 | 9196 | 9177 | 9175 | 9177 | 918 | 920 | 917 |
| % C6 (IR) | 9.8 | 11.4 | 11.64 | 10.5 | 10.5 | 11.4 | 11.2 |
| % > 125° C. (DSC) | 48.3 | 45.3 | 42.5 | 40 | 39 | 37.8 | 40.5 |

All the values of %>125° C. obtained in the case of these examples are lower than those expected by the model determined on the basis of the three polymerisation references (comparative example 1: %>125° C.=−2.7(%C6)+74.8), showing the improvement of SCBD.

Activity and productivity are the average during the test

g/mmol Ti/b/h=weight polymer (g)/Ti added to reactor(mmol)/ethylene pressure (bar)/time (minutes)×60

g/g/b/h=weight polymer (g)/catalyst weight added to reactor (g)/ethylene pressure (bar)/time (minutes)×60

MI=melt index (MI2.16) of the polymer (measured according to ASTM-D-1238)

MFR (melt flow ratio)=ratio of the high load melt index (HLMI21.6) to the melt index (MI2.16) of the polymer

The density is measured according to ASTM/D2839

%C6=optical density ratio of the methyl band absorption at 1378 cm−1 over methylene band at 1365 cm−1.

%>125° C.=fraction of low branched molecules determined by the melting enthalpy above 125° C.(%>125° C.), measured by Differential Scanning Calorimetry PERKIN-ELMER DSC7 Differential Scanning Calorimeter.

The catalyst granulometry is measured with a MALVERN granulometer 2600 C. The principle is to send a laser beam of low energy (2 mW) across the measurement cell containing a powder sample. The beam is diffracted and the values of the angles of diffraction depend on the particles size. In the case of the above catalysts, the sample is first deactivated under a wet nitrogen flow, then is introduced with a dispersant composed of water+aceton in the MALVERN measurement cell PS5.

C. Gas Phase Testing

The catalysts prepared according to example 1 and comparative examples 1 and 2 were respectively evaluated into a fluidised bed gas phase polymerisation reactor consisting of a vertical cylinder of diameter 0.74 m and height 7 m and surmounted by a velocity reduction chamber.

The polymerisation conditions and product properties are summarised in the following table.

| | Comp ex 2 | Comp ex 1 | Ex. 1 |
|---|---|---|---|
| Temperature (° C.) | 85 | 85 | 85 |
| PC2 (bar) | 4 | 4 | 4 |
| PH2/PC2 | 0.23 | 0.219 | 0.25 |
| PC6/PC2 | 0.21 | 0.227 | 0.29 |
| pellet MI (2.16) | 0.84 | 0.89 | 0.86 |
| pellet MFR | 27 | 26.9 | 27.6 |
| Density n.a | 915.8 | 915.3 | 915 |
| Blocking (6 mm) | 1 | 0.72 | 0.29 |
| Dart impact | 435 | 480 | 770 |
| % > 125° C. (DSC) | 54 | 52.7 | 48 |

The value of %>125° C. obtained in the case of example 1 is lower than those obtained with the two comparative examples, showing the improvement of the SCBD. This is not the only improved properties since the dart impact (measured according to ASTM-D-1709-85) is improved/increased. The catalyst in example 1 leads also to a polymer with a better/lower blocking (measured according to ASTM-D-1893-85).

1. Catalyst composition for the (co-)polymerisation of ethylene, optionally with an alpha olefin of 3 to 10 carbon atoms, comprising a catalyst precursor and an organoaluminium cocatalyst, wherein the catalyst precursor comprises
i) a catalyst carrier material, having from 0.3 to 1.2 mmoles of OH groups per gram of catalyst carrier,
ii) a dialkylmagnesium compound of the formula RMgR^{1,} where R and R¹ are the same or different C2-C12 alkyl groups, in an amount comprised between 1.3 and 2.4 mmoles of dialkylmagnesium per gram of catalyst carrier,
iii) a tetraalkyl orthosilicate, in which the alkyl group contains from 2 to 6 carbon atoms, in an amount comprised between 0.4 and 1.6 mmoles of tetraalkyl orthosilicate per gram of catalyst carrier, and
iv) a titanium compound in an amount comprised between 1.1 to 2.4 mmoles per gram of catalyst carrier.

2. Catalyst composition according to claim 1 wherein the catalyst carrier material has from 0.3 to 0.8 mmoles of OH groups per gram of catalyst carrier.

3. Catalyst composition according to any of the preceding claims wherein the amount of dialkylmagnesium compound is comprised between 1.3 and 1.8 mmoles per gram of catalyst carrier.

4. Catalyst according to any of the preceding claims wherein the molar ratio between the magnesium of the dialkylmagnesium compound and the OH groups of the silica carrier is higher than 2.5.

5. Catalyst according to claim 4 wherein the molar ratio between the magnesium of the dialkylmagnesium compound and the OH groups of the silica carrier is higher than 3.

6. Catalyst according to any of the preceding claims wherein the amount of tetraalkyl orthosilicate is comprised between 0.6 and 1.3 mmoles per gram of catalyst carrier.

7. Catalyst according to any of the preceding claims wherein the amount of titanium compound is comprised between 1.3 to 2.4, preferably between 1.3 to 1.8 mmoles per gram of catalyst carrier.

8. Catalyst according to any of the preceding claims wherein the catalyst precursor consists of the four (i) to (iv) compounds.

9. Method for the preparation of a catalyst precursor via a multi-step process which comprises the steps of:
(1) reacting in a solvent a catalyst carrier material, having from 0.3 to 1.2 mmoles of OH groups per gram of catalyst carrier, with a dialkylmagnesium compound of the formula RMgR^{1,} where R and R¹ are the same or different C₂-C₁₂ alkyl groups, in an amount comprised between 1.3 to 3 mmoles of dialkylmagnesium per gram of catalyst carrier, more preferably between 1.5 to 2.6 mmoles of dialkylmagnesium per gram of catalyst carrier,
(2) extracting the supernatent solution and washing the product from step (1) up to obtain less than 1% of magnesium compound in the last extraction in comparison with the amount of Mg initially added during the reaction, and from 1.3 to 2.4 mmoles of dialkylmagnesium per gram of catalyst carrier, more preferably from 1.3 to 1.8 mmoles of dialkylmagnesium per gram of catalyst carrier,
(3) reacting said carrier supported organomagnesium composition with a tetraalkyl orthosilicate, in which the alkyl group contains from 2 to 6 carbon atoms, in an amount comprised between 0.4 to 1.6 mmoles per gram of catalyst carrier, more preferably between 0.6 to 1.3 mmoles per gram of catalyst carrier, and
(4) contacting the product from step (3) with a titanium compound in an amount comprised between 1.3 to 2.4 mmoles per gram of catalyst carrier, more preferably between 1.3 to 1.8 mmoles per gram of catalyst carrier.

10. Method for the preparation of a catalyst precursor according to claim 9 wherein the multi-step process consists in the four steps (1) to (4).

11. Catalyst precursor obtainable by the method of claims 9 or 10.

12. Use of a catalyst precursor according to any of claims 1 to 8 and 11 in combination with an organoaluminium cocatalyst for the (co-)polymerisation of ethylene, optionally with an alpha olefin of 3 to 10 carbon atoms, wherein the resulting polyethylene has an improved short chain branching distribution.

13. Use of a catalyst precursor according to any of claims 1 to 8 and 11 in combination with an organoaluminium cocatalyst for the (co-)polymerisation of ethylene, optionally with an alpha olefin of 3 to 10 carbon atoms, wherein the resulting polyethylene has an improved dart impact.
